(19) United States
(12) Patent Application Publication
(10) Pub. No.: US 2004/0100099 A1
(43) Pub. Date: May 27, 2004

(54) Magnetic field power converter

(76) Inventors: Peter T. Eaton, Clarksville, VA (US); Christopher T. Johnson, Skipwith, VA (US)

Correspondence Address: Peter T. Eaton, Christopher T. Johnson, 850 Kinderton Rd., Clarksville, VA, 23927, US

(21) Appl. No.: 10/425,657

(22) Filed: Apr. 30, 2003

Related U.S. Application Data
(60) Provisional application No. 60/429,345, filed on Nov. 27, 2002.

(51) Int. Cl. H02P 9/04

(52) U.S. Cl. 290/1 R

(57) ABSTRACT

By this invention, The Magnetic Field Power Converter, which we call “Magi”, is disclosed which extracts the potential energy inherent in the atomic structure of it's magnet(s) and transforms it into generated electricity and the kinetic energy and torque of a rotating, integral driveshaft. The “Magi” consists of a unique arrangement of permanent magnet(s) and air-solenoid/electromagnet(s), coupled with a standard automotive battery and unique design “Pulser” electro-mechanical device we have developed. Brief, timed, pulses of direct current, from the battery to the coils of the air-solenoid/electromagnet, thru the “Pulser”, energize the coils. The resulting electromagnetic field repells the permanent magnet causing it and the integral driveshaft it is mounted on to rotate and alternating current to be generated in the coils. By this invention, we also disclose that we have discovered that if one “Magi” unit is operating and a second “Magi” unit is placed in close physical proximity to the first unit, the second unit will operate, and generate electricity and torque in the driveshaft, even though the second unit is not connected to the battery.

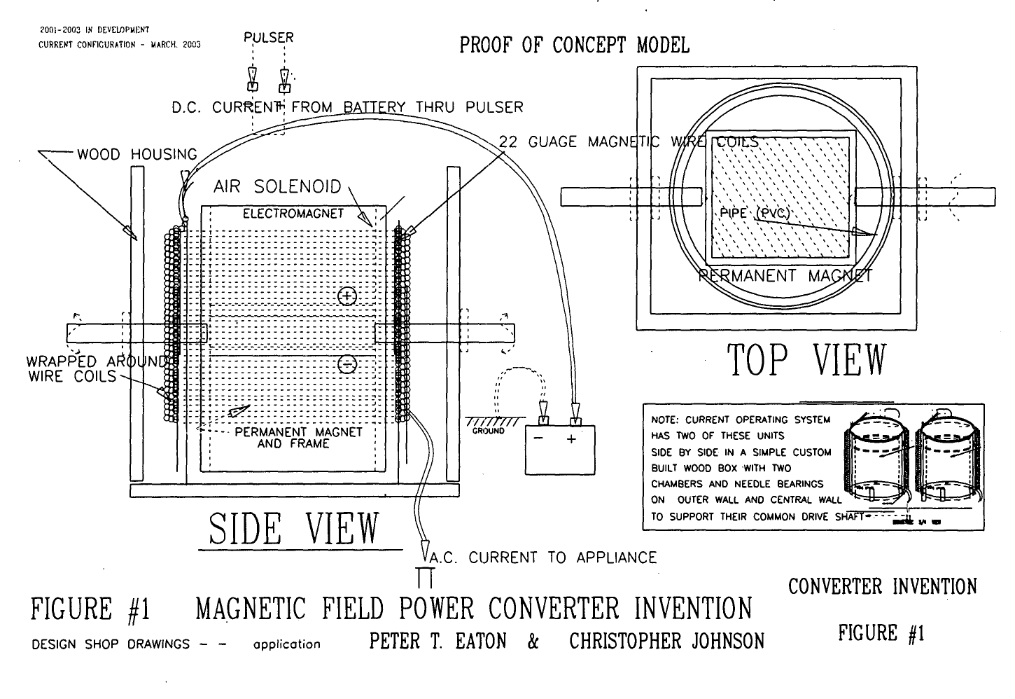

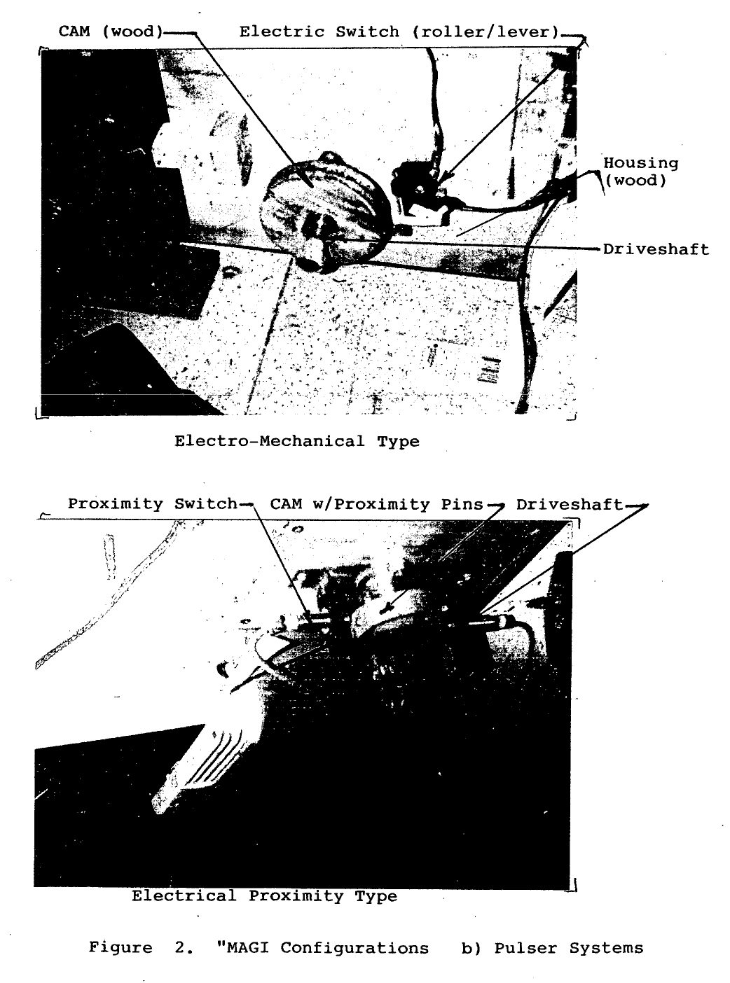

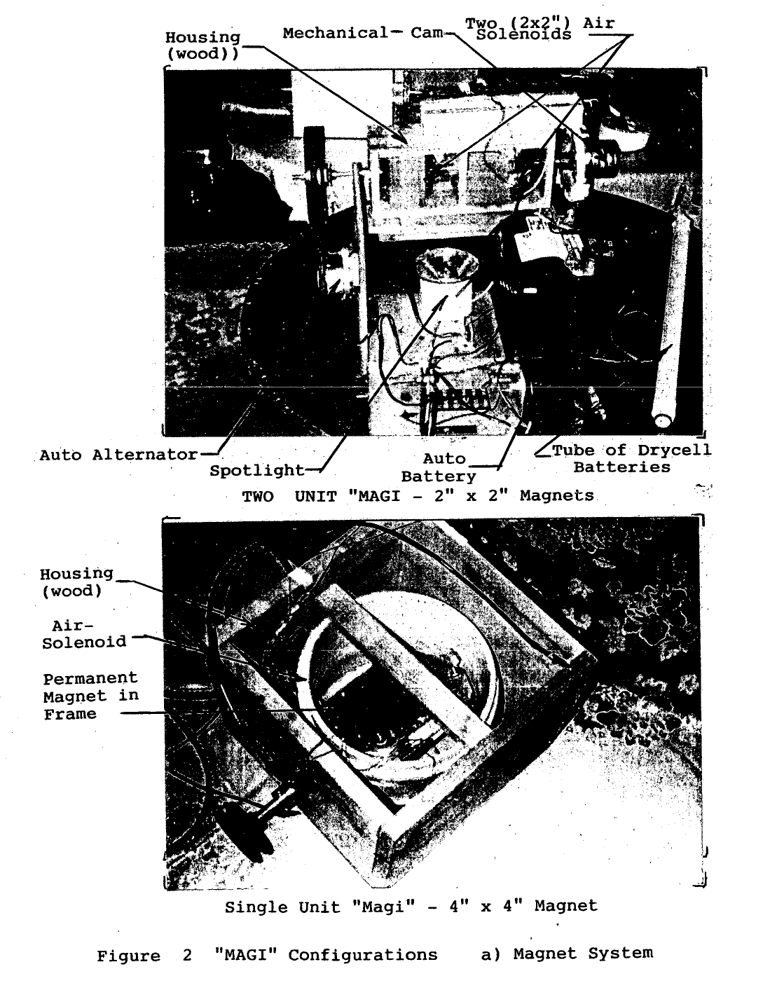

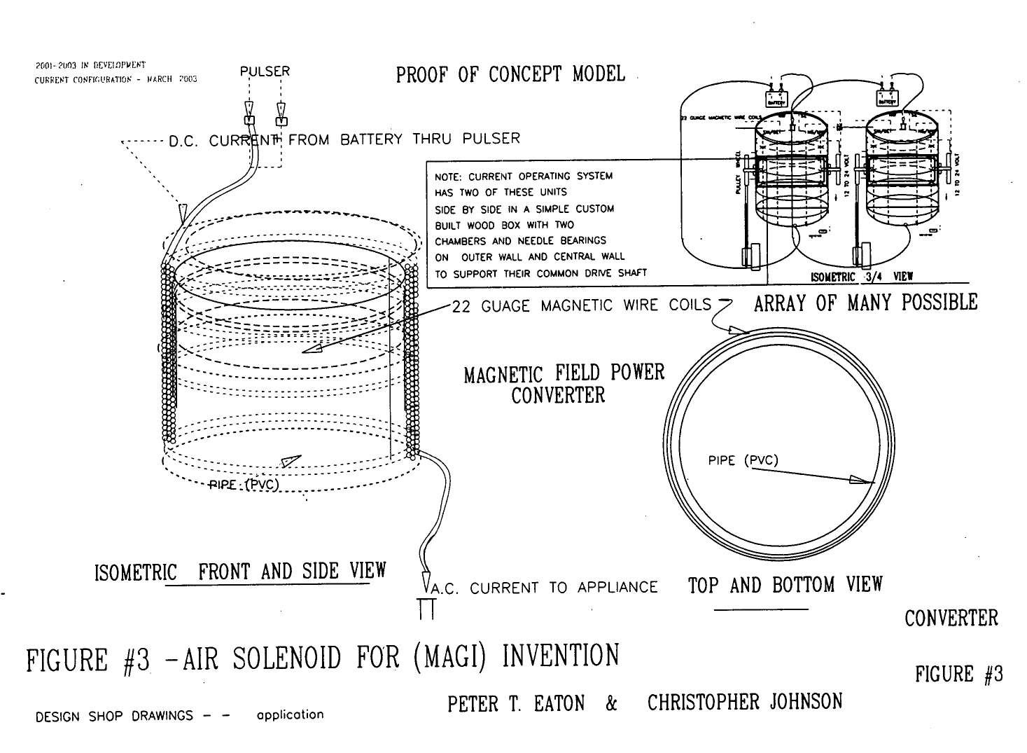

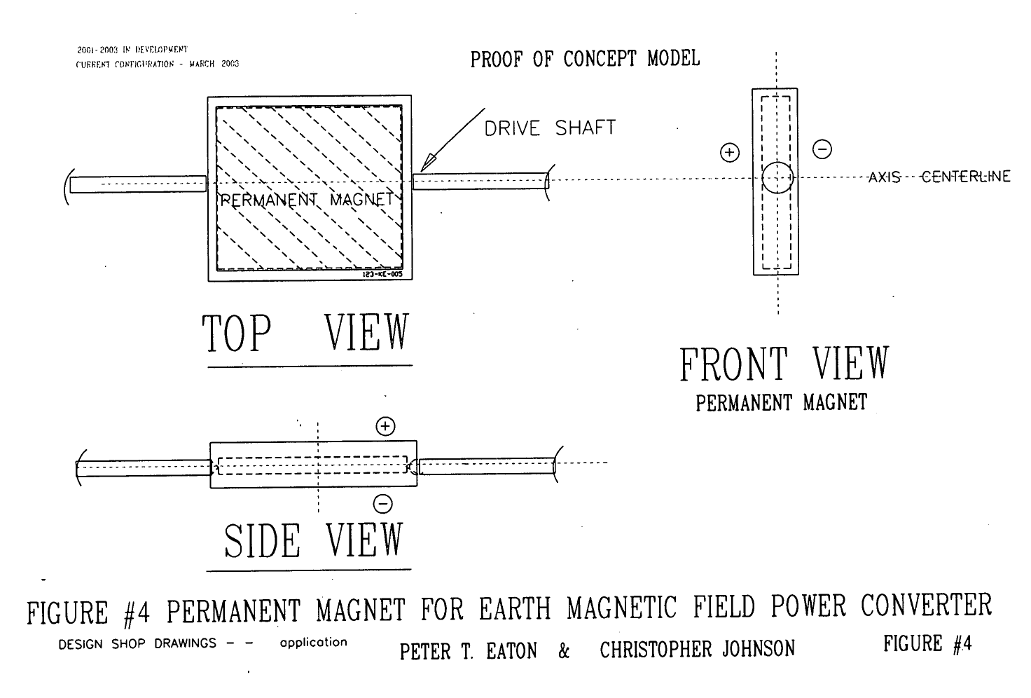

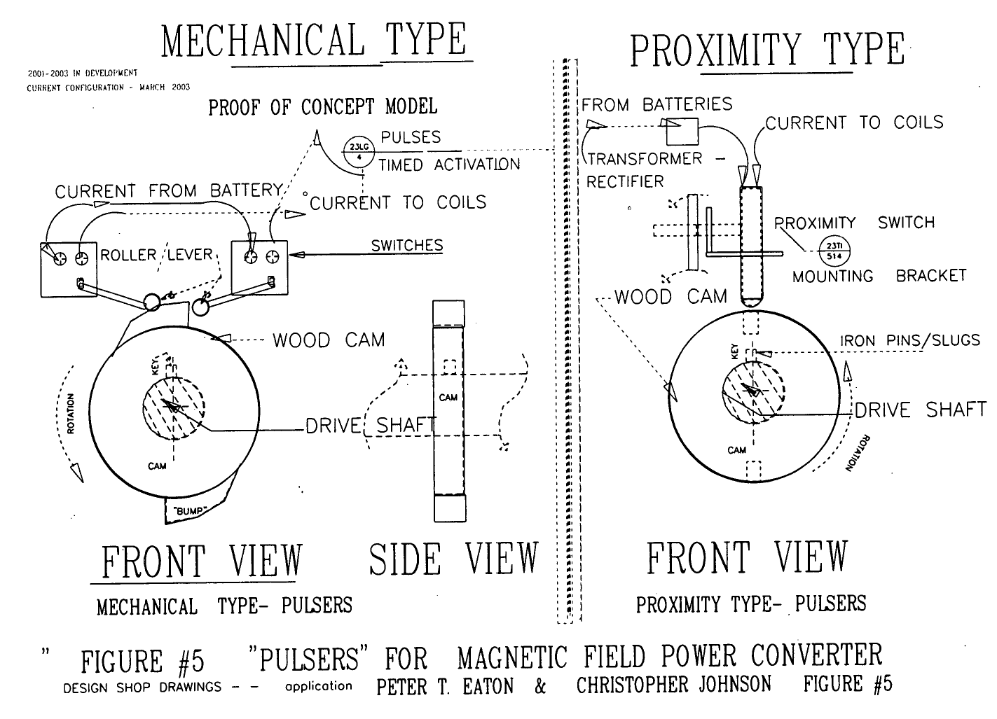

### BACKGROUND OF THE INVENTION

The economies of the modern, global, industrialized world continue to expand and they require an ever increasing supply of power their machinery and their vehicles. This power has been supplied for the past century by internal combustion engines and, electric motors and generators. These devices convert potential energy found in nature into the kinetic energy of the torque of a rotating driveshaft which in turn generates electricity, operates a machine or appliance, or turns a wheeled axle. The source of choice for this has been fossil fuels—oil, coal, wood, natural gas—because their potential energy can be extracted mostly easily—by simply burning them. Unfortunately, the increasing use of these fuels has led to two major global concerns—environmental damage and health problems resulting from atmospheric pollution and increasing, critical dependence on oil from the increasingly unstable and dangerous Middle-East.

Like numerous other individuals and organizations, we decided to search for a new and better way to supply at least some of the worlds power needs by some means that greatly reduced or eliminated some of this pollution and oil dependence by totally avoiding burning any fuel. Accordingly, we experimented with a variety of designs that are based on magnets arranged in electromechanical devices in such a way that the potential energy that maintains the atomic structure of the magnets is extracted and converted into generated electricity and torque of a rotating, integral driveshaft. We have succeeded and the resulting design is the subject of this Patent Application.

The only “Documents Known to Us” in this development effort are standard textbooks on electricity, magnetism, electric motors and generators and internal combustion engines—none of which envision or discuss the several unique design features of our invention. We submitted a Disclosure Document to the USPTO on 21 Apr. 2002 on the basic concept of this invention entitled “The Earth's Magnetic Field Power Converter” which was accepted and assigned the registration number 510748. We submitted a Provisional Patent Application to the USPTO thru the “Small Entity Program”, under the same title, on 27 Nov. 2002 which was accepted and assigned the registration No. 60/429,345 and confirmation number 5898 dated 30 Dec. 2002.

### SUMMARY OF THE INVENTION

Our invention, The Magnetic Field Power Converter, which we call “Magi”, is a unique arrangement of custom-built magnets and electromechanical components that generate electricity and create torque in an integral rotating driveshaft. Direct current from a standard lead battery, or a string of standard dry cell batteries, energizes magnetic wire coils of a custom built air-solenoid which therefore acts as an electromagnet. However, this current is processed thru a system we designed that we call a “Pulser” which converts the current into a periodic series of brief pulses instead of a steady flow of current as is done in existing electric motors and generators so as to minimize the rate of using current from the battery and thus maximize the time between recharges. Each pulse is timed to briefly energize the coils and create a momentary electromagnetic field at the precise moment a permanent magnet is in a position to cause maximum repelling force between the two. The driveshaft is attached to the permanent magnet in such a way that when the magnet is repelled it rotates—and so does the driveshaft. This process mimics the behavior of an internal combustion engine—but with a huge beneficial difference—our invention does not involve burning fossil fuel from the Middle-East and therefore does not pollute the atmosphere. We believe there is another great potential benefit from not burning fuels the “Magi” itself ,and all appliances and vehicles it is used with could be made of new non-metallic materials that are very light weight which would greatly improve efficiency of all operations, reducing greatly the overall need for power of all types. Of equator, perhaps greater importance is that we have discovered that an alternating current (not direct current and therefore not a simple “pass-thru” from the battery) is being generated in the coils, we believe by the reverse effect of the rotating permanent magnet on the emf. The coil wire can be connected to any electric appliance and make it operate without the need to be within reach of an electric wall outlet—which would be a huge advantage in any application in a remote location since our battery current useage is so low and recharging would be so infrequent. Finally, we have discovered that if we place a second “Magi” unit in close physical proximity to the first unit while the first unit is operating, the second unit auto initiates operation itself, generates electricity (also alternating current), and rotates it's driveshaft—and it does so even though it is not connected to the battery. There appears to us to be a great potential benefit from installing such “slave” units in proximity to a large operating “Magi”, or even a conventional existing fuel burning turbine generator in existing centralized powerplants, vastly increasing electricity output of the plant without burning additional fuel.

The advantage of our system over existing systems in applications such as lawnmowers, go-carts, ski-doos (which are a prime source of pollution in fresh water lakes and rivers), electric light generators and fresh water pumping operations in poor remote areas and appliances in campers and RV's would seem obvious—and highly desireable—and beneficial.

### DETAILED DESCRIPTION OF THE INVENTION

Our invention,“The Magnetic Field Power Converter”—which we call “Magi”—consists of three major elements—one or more: a) electromagnet(s), b) permanent magnet(s),and, c) electric current “pulser(s). These are all shown and identified in the sketch of the entire invention in FIG. #(1) and the photographs in FIG. #(2). All three elements of our invention had to be custom built because their equivalents were not commercially available for off-the-shelf purchase nor development in any reasonable time or cost.

a) the electromagnet(s) are probably better described as custom-built air-solenoids. The actual size of the air-solenoid we built for our Proof-of-Concept operating model was chosen arbitrarily based primarily on the ready and inexpensive availability of it's components. Other sizes could be used as long as the unique geometry of the configuration is maintained. We arbitrarily took one foot lengths of either three-inch and five inch I.D. standard PVC pipe (that plumbers use), sandpapered the outer surface and wrapped them in roughly 2,000-feet of # 22-guage coated magnet wire coils as shown in the sketch in FIG. #3. Any diameter pipe can be used and depends only on the dimensions of the permanent magnet with mounting frame which must rotate inside of it. The gauge of the coil magnet wire is also arbitrary to some extent. We chose #22 gauge as likely to be able to survive any heat of resistance it caused while generating electricity excess to that used energizing the coils to create the EMF. Our particular model generates up to roughly 40-volts and 2-amperes, but we suspect an infinite number of combinations of volts/amps could be generated by assembling larger or smaller units. Since this electricity we generate is alternating current, it must be coming from the cyclical rotation of the permanent magnet and is not just a partial pass thru of the current from the battery(s) which is direct current. We found some improvement in the strength of the energized field if each layer of coils goes from each end to the middle and is separated by light paper from the next layer above it.

The purpose of this air-solenoid is to create a typical electromagnetic field, when the coils are energized by an electric current, both inside and outside the PVC pipe of the type illustrated in any standard iron-filings display. However, the electromagnetic field we create is not continuous, but rather consists of brief intermittent periods that occur when the coils are energized by brief pulses of electric direct current from the battery(s). We have assembled our model unit to supply an electric pulse twice per rotation cycle of the permanent magnet/driveshaft assembly—each when the assembly is vertical (180 and 360 degrees) when it can achieve maximum repelling force between the EMF and the positive face of the permanent magnet. We surmise that future development projects of units, with more exqusite microelectronics for timing, may find other combinations of pulses per cycle that prove even more efficient.

This is one of the principal new characteristics of our invention. We drain only a tiny amount of current from the battery(s) for each pulse rather than draw on it continuously, as all existing electric motors do. Therefore, the battery(s) lasts much, much longer—which is one of our primary goals which makes our invention unique—and useful. This characteristic will be crucial in use with appliances in remote locations where operational endurance between recharges of the battery(s) must be much longer than now possible with existing power sources. This will be crucial also for applications involving propelled vehicles such as electric or hybrid automobiles, lawnmowers, golf carts, ski-doos, etc where the rotating driveshaft of “Magi” is connected by pulley/belt or sprocket/chain to their wheeled axle etc. and acceptable endurance between recharges

b) the permanent magnets themselves were purchased from the only company willing to do so—primarily because they were the only with a new product development lab geared to do this sort of thing for themselves. However, we were limited to units that were 2″×2″×1″ and 4″×4″×1″ for which they already had experimental molds. They were made of poured neodymium which has the most powerful and long-lasting magnetic characteristics. They were made with a negative, attracting face on one side and a positive repelling face on the other and were not mounted in standard commercial housings which blocked the positive repelling face for standard applications. Neodymium is too brittle to be machined so for the 2×2 magnet we simply took a 1″ thick piece of aluminum plate, cutout a 4″ diameter cicular disk, routed out a 2″×2″ square hole in the center, installed the 2″×2″ permanent magnet in the square hole and then covered both sides of the disk with ⅛″ thick, 3-in. diameter pieces of Plexiglas and screwed them to the aluminum disk to hold the magnet in place so it could not move during operations, creating an assembly we call a “picture frame”. For the 4″×4″ magnets we took a piece of 1″×1″ aluminum square bar stock and cut it into 6″ lengths. Then we routed a 1″ groove in the side of each piece that the magnets could slide into. Finally, we sawed 45 deg ends on each piece for corners that could be screwed together to make a “picture frame”, and again we covered the assembly with Plexiglas in the manner noted above, and, as shown in the enclosed sketch in FIG. #4. We drilled and tapped holes in ths two sides of each “picture frame” and then cut matching threads on the ends of lengths of ½″ diameter stainless steel (non-magnetic) rod that would be used to mount the permanent magnets/frames inside the air-solenoid pipe, perpendicular to the pipe's longitudinal axis as shown in FIG. #4. The rods are passed thru two ½″ diameter holes drilled in the side of each air-solenoid pipe and screwed into the tapped holes in the “picture frames” as shown in FIG. #4 and become the driveshaft of the “Magi”. Thus, when the air-solenoid coils are energized by a pulse from the battery, its EMF and the positive face of the permanent magnet, repell each other ,and “picture-frame”—and the driveshaft rotate—which was our other goal. This new, unique, innovative arrangement has never been utilized before and is a critical characteristic of our invention that is crucial to our invention successfully doing work—generating alternating current to use to run electric appliances and rotating a driveshaft and generating torque that could move wheeled vehicles as noted above. Obviously, the alternating current and driveshaft torque could be increased or decreased substantially to match the requirements of the job by increasing the size of the face (not thickness) of the permanent magnets and using any number of units (we used either one or two, for simplicity and cost and schedule control) and presumably future developments would include repacement materials for the neodymium that have superior magnetic properties.

c) the electric current “pulser” we designed and developed has a crucial and innovative role in the unique functions of our “Magi” invention. It allows the minimum use of direct current from the battery(s) by providing pulses to the air-solenoid coils. The requirement of standard electric motors for continuous flow of electricity is what so severely limits the endurance in mobile or remote applications where unlimited supply of alternating current from a wall outlet is not available. We have actually developed and successfully operated two “pulser ” designs—one purely mechanical and one electro-mechanical. The mechanical design consists of a cam made out of a simple wooden (non-magnetic) disc with two “bumps, 180 deg apart on it's outer circumference as shown in FIG. #5 The cam has a central hole that slides onto the driveshaft and is keyed to it so they rotate together; 2) two standard, commercially available roller/lever electric switches, mounted atop the Magi wooden housing such that the “bumps” strike and lift the two roller/levers as they pass by. This causes the switch to close the circuit between the battery(s) and the air-solenoid coils which are both wired to it. The “bumps” are located such that they close the circuit and energize the coils precisely at the moment the permanent magnet(s) are vertical in the EMF for maximum repelling force and driveshaft rotation/torque—twice each cycle—at 180 and 360 deg. We had difficulty for some time with the switches failing in fatique due to extended operation and high rotation rates for which they were not designed—but we have recently more sturdy switches and learned how to install them with better alignment so that they now suitable to our requirements in most applications. In parallel we developed an electromechanical “pulser” system (again see FIG. #5) that includes: a cam, again mounted on the driveshaft by a central, keyed hole, with two radial iron pins or “slugs” imbedded in the wooden disc 180 deg apart; a standard, commercially—available, proximity switch that is mounted in a simple bracket screwed onto the air-solenoid housing in place of the switches, such that when the slugs rotate into the plane of the proximity switch they activate it electronically and it closes the circuit between the battery(s) and the coils; the activation of the proximity switch itself requires only a fraction of the power from the battery so the proximity switch activation circuit (not the primary circuit between battery and coils) includes a special built transformer/rectifier device that conditions the input to it. We prefer the electro-mechanical “pulser” because there is no mechanical contact between components so lifetime should be extensive regardless of driveshaft rotation rate or duration. Obviously, any number of combinations of these components could be used to make a “pulser” so the size and characteristics of the ones we chose arbitrarily is not critical—the arrangement of the components and their integration with the other elements of the “Magi” is what is unique and crucial to our invention

Finally, we wish to note here a unique discovery we made while designing/developing the “Magi” configuration. We had built two models of “Magi”—the first one built around two 2″×2″ permanent magnets in their air-solenoids and wooden housing and the second one built around only one 4″×4″ permanent magnet ,in it's air-solenoid and wooden housing (see FIG. #(2) ).We connected the first one to the battery thru it's “pulser”,energized it's coils and it's permanent magnet and driveshaft proceeded to spin. We then placed the second one alongside the first one such that their wooden housings almost touched. The second one was not connected to the battery and yet it's permanent magnet and driveshaft also proceeded to spin, generating torque and excess alternating current from it's coils. The operation of the second “Magi” does not appear to reduce the performance of the first one or the battery—or at least, the effect is so small our simple instrumentation cannot measure it. We believe the implications of this to the design of electricity generating powerplants is potentially significant.

What is claimed is:

1.) a magnetic field power converter consisting of a unique physical arrangement of permanent and electro magnets, fabricated to our specifications, coupled with a standard direct current battery and an electromechanical “pulser” device designed and built by us, that extract the potential energy that is inherent in the atomic structure of the magnets—and perhaps in the local earth's gravitational field—and transform it into generated alternating current and the kinetic energy of a rotating integral driveshaft

2.) a magnetic field power converter described in claim (1) above that can cause second unit, when placed in close physical proximity to the first unit, to operate and generate alternating current and rotate an integral driveshaft to provide torque, even though the second unit is not connected to the battery

3.) a magnetic field power converter described in claim (1) above, that has special custom built permanent magnet(s) in a frame mounted on an integral driveshaft so that it can be located perpendicular to the longitudinal axis of the air-solenoid/electromagnet and be free to rotate in repelling reaction to the electromagnetic field created by the air-solenoid/electromagnet when it's coils are electrically energized

4.) a magnetic field power converter described in claim (1) above, that has a custom built air-solenoid/electromagnet made from a simple length of PVC pipe with coils of magnet wire wrapped around it's exterior periphery that are energized and create a classic electromagnetic field both inside and outside the pipe when they are intermittently fed brief pulses of direct current from a standard automotive battery thru our custom designed “pulser” device

5.) a magnetic field power converter described in claim (1) above, that includes a custom built electromechanical device we call a “pulser” consisting of a custom made “cam” mounted on the driveshaft which activates either a electromechanical roller/lever switch or a custom built proximity switch at the precise moment the permanent magnet is physically oriented to gain maximum repelling force from the electromagnetic field and do so by delivering only a brief pulse of current so as to minimize the rate of depletion of the battery
